(19) United States
(12) Patent Application Publication
(10) Pub. No.: US 2020/0179829 A1
(43) Pub. Date: Jun. 11, 2020

(54) GRANULAR FILTRATION SYSTEM FOR AGRICULTURAL IRRIGATION

(71) Applicant: ZOTEXA, LLC

(72) Inventors: Landon Friend, Newark, DE (US); Ofer Rosenfeld, Hanford, CA (US)

(73) Assignee: ZOTEXA, LLC, Newark, DE (US)

(21) Appl. No.: 16/705,126

(22) Filed: Dec. 5, 2019

Related U.S. Application Data
(60) Provisional application No. 62/775,394, filed on Dec. 5, 2018.

(51) Int. Cl. B01D 24/10; C02F 1/00; B01D 24/46; B01D 29/50; B01D 29/66

(52) U.S. Cl. CPC B01D 24/105; C02F 1/004; C02F 2103/26; B01D 29/50; B01D 29/66; B01D 24/4631

(57) ABSTRACT

The present invention may provide a granular filtration system for filtering effluent water for agricultural operations. The system may comprise a granular media for filtering the effluent water, a vessel for holding the granular media, a filtration inlet, a filtration outlet, a backflush inlet, a backflush outlet, a plurality of filtration members, and a plurality of conduits, the conduits being in fluid communication with the plurality of filtration members, the filtration outlet, and the backflush inlet. The vessel may further comprise a plurality of access ports for accessing the interior of the vessel. The present system provides filtration members with sufficient size, shape, number, and placement to efficiently and evenly backflush the granular media, and a higher quality, hydrodynamically shaped tank which can be backflushed at a lower pressure, reducing water and energy use, leaks, and inconsistencies in the granular media.

### FIELD OF THE INVENTION

The present invention relates to improved filters and filtration methods for filtering agricultural waste water. More specifically, the present invention relates to granular filtration systems agricultural irrigation having improved backflushing efficacy, and methods of using the same.

### DISCUSSION OF THE BACKGROUND

Drip irrigation systems have quickly become an industry standard for the irrigation of tree, row, and forage crops in arid environments. The slow and precise application of water, as well as the precise application of injected nutrients via drip systems, has led to higher yields for growers. Water and energy savings are also realized with drip irrigation systems.

Many agricultural operations also take advantage of nutrient-rich effluent water sources available for reclamation and re-use in drip irrigation, including drinking water for the animals, misters and other climate control systems, refrigeration systems, and lane flushing systems. After water is used for its various purposes in an agricultural setting, it ends up draining to settling ponds. As water shortages and the drought continue to worsen, it has become more valuable for farmers to utilize every drop of nutrient-rich effluent water to the greatest extent possible.

However, such reclaimed effluent water must be filtered to remove particulate matter down to a fine scale in order to prevent clogging of the small-diameter outlets of the drip lines. To this purpose, large-scale drip irrigation systems commonly mix and pressurize the effluent water with fresh water and utilize one or more sand media filtration tanks to filter debris from the blended water.

Current sand media filtration tanks utilize filtration pods or wands buried in a large volume of sand. Reclaimed water is pumped into the tank and must filter through the sand in order to arrive at and pass through small openings in the pods or wands, the openings permitting water to pass through but preventing the passage of sand and other debris large enough to clog drip lines. The interior of the pods or wands are in fluid communication with a conduit which leads to the filter outlet. Such systems come with the advantages of large capacity and few moving parts, but must be frequently backflushed in order to clean accumulated debris from the sand and keep up sufficient pressure at the filter outlet.

However, many drip irrigation systems only require fresh water pressures of about 8-10 psi in order to function, while conventional sand media filter systems typically require 30-35 psi of fresh water for an adequate backflush session. Thus, extra pumping equipment, which means extra equipment cost and expended energy, is required for their use. Further, conventional sand media filter systems typically do not provide a sufficient number or size of filter members (i.e., pods or wands), nor an efficient design for their placement to sufficiently cover the area of the bottom of the tank. Conventional sand media tanks are generally made with thin, non-stainless steel which quickly succumbs to rust spots inside the tank. Also, the tanks are often shaped with sharp angles which are not conducive to the hydrodynamics of water being backflushed upwardly through the sand media, and create a high pressure at welded corners causing loss of water pressure at the flush outlet, and leaks.

Together, these inadequacies lead to uneven flow during backflushing, which necessitates longer backflushing sessions, using more water to remove debris from the sand media. Further, after a backflushing session the sand media is left with an uneven surface and mottled areas of finer and courser sand, decreasing the sand media's capacity to continue efficiently filtering effluent water.

Therefore, improved filtration systems are needed.

### SUMMARY OF THE INVENTION

The present invention provides a granular media filtration system for filtering effluent water for use in irrigation. The system may provide a granular media filtration system with sufficient size, shape, number, and placement of filter members, and a higher quality, hydrodynamically shaped tank which can be backflushed at a lower pressure, reducing water and energy use, leaks, and inconsistencies in the granular media. The system may comprise a vessel partially filled with granular filtration media for filtering effluent water, the vessel having a filtration inlet in fluid communication with an effluent water source, a filtration outlet in fluid communication with an irrigation device (e.g., a drip line), a backflush inlet in fluid communication with a fresh water source, and a backflush outlet. The system may further comprise at least one conduit positioned inside the vessel, the conduit being in fluid communication with the filtration outlet and the backflush inlet, and the conduit having a plurality of filtration members mounted thereon. In some embodiments, the at least one conduit may be a plurality of conduits, extending in an evenly spaced manner from a central hub. The filtration members may each have a plurality of openings sized to allow water to pass through the filtration member but prevent the inward passage of the granular filtration media.

The system may provide improved and efficient flow in the filtration direction and may reduce loss of pressure and improve flushing of debris and residue in the backflushing direction.

The present system provides a higher concentration and more beneficial placement of filtration members across the area of the bottom of the vessel than conventional sand media filtration tanks. The present system also utilizes filtration members having greater dimensions (e.g., height and diameter) than conventional tanks, providing a greater area of openings (i.e., slots) for water to pass from the granular media into the conduits during filtration, and vice versa during backflushing. This allows for effluent water to more uniformly sink into the granular media, and for the water which has filtered down into the granular media to more readily pass through a filtration member and down a conduit to exit via the filter outlet.

The arrangement and high concentration of filtration members also allows the fresh water being pumped up through the granular media during a backflushing session to better and more evenly disturb, and thereby wash, the entirety of the granular media across the area of the bottom of the vessel. The flow of water through the vessel of the present system is also improved by the more hydrodynamic shape of the vessel. The system provides a vessel with a gently curving shape having few sharp angles, thus avoiding disturbances of the flow of fresh water passing upwardly through the granular media and out through the backflush outlet at the top of the vessel. This allows the system to utilize a lower pressure fresh water source.

The improved placement and the greater number and size of the filtration members, together with the improved shape of the vessel, allow for improved draining of effluent water during filtering, and unimpeded, higher volume flow of fresh water during backflushing. The system is thus able to effectively backflush the granular media with less overall volume of fresh water, in less time, and utilizing a fresh water source at a lower pressure. The present system therefore helps agricultural operations reduce both water consumption and energy usage. Additionally, the improved and balanced flow of water during a backflushing session leaves the granular media cleaner, and with a level surface and a heterogeneous consistency, allowing the present system to continue filtering effluent water at a greater efficiency than conventional sand filtration tanks.

The present system also utilizes thicker, higher quality material for the walls of vessel (e.g., stainless steel, aluminum, steel with chromium alloy cladding, steel with aluminum cladding, etc.), preventing pinhole rust spots on the surfaces and leaks which commonly occur at the welded corners and seams of conventional systems. Finally, while conventional sand media filtration tanks generally provide only an upper port and a lower port for filling and draining the sand media, the vessel of the present system may comprise a plurality of access ports (e.g., four or more) to the interior of the vessel, providing improved access to the interior components of the vessel (e.g., the filtration members, hub, conduits, and granular media), each port having a door which may be sealed in a watertight manner.

The present invention may provide a granular filtration system for filtering effluent water for agricultural operations. The system may comprise a granular media for filtering the effluent water, a vessel for holding the granular media, a filtration inlet, a filtration outlet, a backflush inlet, a backflush outlet, a plurality of filtration members, and a plurality of conduits, the conduits being in fluid communication with the plurality of filtration members, the filtration outlet, and the backflush inlet. The vessel may further comprise a plurality of access ports for accessing the interior of the vessel.

In some embodiments, the vessel may comprise a shape having a cylindrical medial section with substantially hemispherical upper and lower sections, providing a gently curving transition between the medial section and each of the upper and lower sections. In other embodiments, the vessel may comprise substantially spherical shape, an oblate spheroid shape, or a prolate spheroid shape. The vessel may thus comprise a hydrodynamic shape, without sharp or acute angles to interrupt the flow of water from the bottom of the vessel (e.g., from the filtration members) to the top of the vessel (e.g., to the backflush outlet at an apex of the vessel). The vessel may also provide a hydrodynamic shape for the flow of effluent water from the top of the vessel (e.g., from the filtration inlet at an apex of the vessel) to the bottom of the vessel (e.g., to the granular media and out through the filtration members).

The vessel may comprise a material which is substantially impervious to rust. In some embodiments, the vessel may comprise at least one of stainless steel or other metal alloy (e.g., stainless steel, aluminum, steel with chromium alloy cladding, steel with aluminum cladding, etc.), aluminum, a plastic, a rubber, fiberglass, carbon fiber, or other similar material. In some embodiments, the vessel may comprise stainless steel of a thickness which prevents leaks at the welded seems of the vessel. In some embodiments, the vessel may comprise stainless steel with no welded seems other than those at the access ports and at the filtration inlet and outlet and backflush inlet and outlet.

The vessel may comprise a plurality of access ports, the access ports being of sufficient size to allow for filling and draining of the granular media, and inspection and maintenance of the granular media, filtration members, and conduits of the present system, which may be located inside the vessel. In some embodiments, the vessel may comprise a first, second, third, and fourth port. The first port may be located in an upper wall of the vessel for pouring granular media into the vessel. The second port may be located in a lower wall of the vessel for easily draining and sweeping the granular media from the vessel. The third port and the fourth port may each be located in a medial wall of the vessel (e.g., approximately midway up the vessel in the outer cylindrical wall) in substantially opposing positions (e.g., on opposite sides of the medial wall). The filtration members, conduits, and granular media may thus be accessed from opposite sides of the vessel, allowing for more thorough inspection and maintenance (e.g., for determining the cleanliness of the granular media, for sweeping the granular media the second port for removal from the vessel, and for monitoring and repairing filtration heads and conduits.)

The filtration inlet may comprise a pipe or other channel providing a watertight connection between the vessel and an effluent water source. The filtration inlet may be connected to the vessel at an apex thereof (e.g., at the highest point of the vessel). The filtration inlet may connect to a first valve at an apex of the vessel, the first valve being operable to switch fluid communication with the vessel from the filtration inlet to the backflush outlet, and back to the filtration inlet. The first valve may comprise a valve well known in the art, operable to switch a flow from a first fluid lead to a second fluid lead (e.g., a three-way ball valve, or other similar valve).

The effluent water source may comprise a mixture of effluent water (e.g., water from a gathering pond at an agricultural operation) and fresh water (e.g., water under pressure from a municipal water source, water from a well pressurized by a pump) mixed upstream of the filtration inlet. The effluent water source may be under pressure sufficient to push water into the vessel, through the granular media, into a filtration member, through a conduit, out the filtration outlet, and through an irrigation device (e.g., drip tape).

The filtration outlet may comprise a pipe or other channel providing a watertight connection between the vessel and an agricultural irrigation device (e.g., drip tape or drip lines). The filtration outlet may connect to a second valve at a low point of the vessel (e.g., at the point where the plurality of conduits converge and connect to the bottom of the vessel), the second valve being operable to switch fluid communication with the vessel from the filtration outlet to the backflush inlet, and back to the filtration outlet. The second valve may comprise a valve well known in the art, operable to switch a flow from a first fluid lead to a second fluid lead (e.g., a three-way ball valve, or other similar valve). The filtration outlet may be in fluid communication with the vessel only by way of the plurality of conduits and the plurality of filtration members, thus preventing any effluent water from entering the filtration outlet without first passing through the granular media and a filtration member.

The backflush inlet may comprise a pipe or other channel providing a watertight connection between the vessel and a fresh water source. The backflush inlet may be connected to the vessel at a low point thereof (e.g., at the point where the plurality of conduits converge and connect to the bottom of the vessel). In some embodiments, the backflush inlet may connect to the vessel via the second valve. The fresh water source (e.g., water under pressure from a municipal water source, or water from a well pressurized by a pump) may be under pressure sufficient to push water through the backflush inlet, through the plurality of conduits, out the plurality of filtration members, through the granular media, and out through the backflush outlet. In some embodiments, the flow of water from the fresh water source exiting the plurality of filtration members may be sufficient to evenly disturb and wash the entirety of the granular media. The backflush inlet may be in fluid communication with the vessel only by way of the plurality of conduits and the plurality of filtration members, thus preventing any fresh water from entering the vessel without first passing through a filtration member.

The backflush outlet may comprise a pipe or other channel providing a watertight connection between the vessel and wastewater exit (e.g., a pipe leading to a gathering pond or a wastewater drain). In some embodiments, the backflush outlet may connect to the vessel at an apex of the vessel via the first valve.

The system may comprise at least one conduit in fluid communication with the filtration outlet, the backflush inlet, and the filtration members. The at least one conduit may comprise a watertight channel upon which a plurality of filtration members are mounted. The at least one conduit may comprise a rigid material (e.g., steel, aluminum, stainless steel or another metal alloy, a plastic, fiberglass, carbon fiber, or other similar rigid material), the plurality of filtration members being mounted to an upper surface thereof. The at least one conduit may comprise any shape which is operable to transport water between the filtration members and either the filtration outlet or the backflush inlet. In some embodiments, the at least one conduit may comprise a substantially rectangular cross-sectional shape.

In some embodiments, the at least one conduit may comprise a shape which allows the filtration members to be mounted thereon such that the entirety of the area at the bottom of the tank (e.g., a cross-section of the tank near the lower edge of the cylindrically shaped medial portion of the tank) is provided with sufficient water drainage in the filtration direction, and sufficient water flow to disturb the granular media in the backflushing direction. In some embodiments, the at least one conduit may comprise a plurality of conduits extending from a central hub, the hub being in fluid communication with the filtration outlet and the backflush inlet.

In some embodiments, the present system may comprise a central hub, and the plurality of conduits may each comprise a radial member and at least one cross-member, the radial member extending substantially radially from the central hub toward the medial section of the vessel, and the cross-member extending substantially perpendicularly from the radial member. The hub may comprise a short, cylindrical shape (e.g., a thick disc shape) in fluid communication with an exit conduit which extends through a low point of the vessel and connects to the filtration outlet and the backflush inlet. In other embodiments, the hub may comprise a polygonal shape, with a number of sides equal to the number of the plurality of conduits extending therefrom. In some embodiments, the exit conduit may connect to the filtration outlet and the backflush inlet via the second valve. In some embodiments, the plurality of conduits may each extend horizontally from the hub. In other embodiments, at least one of the plurality of conduits may extend radially from the hub at an upward angle. In yet other embodiments, at least one of the plurality of conduits may extend radially from the hub at a downward angle.

In some embodiments, the plurality of conduits may comprise a first plurality of conduits and a second plurality of conduits, the first plurality of conduits comprising a cross-member which is positioned distally on the radial member (e.g., the cross-member extends perpendicularly from the radial member at the distal end thereof.) and the second plurality of conduits comprising a cross-member which is positioned medially on the radial member (e.g., the cross-member extends perpendicularly from the radial member at a midpoint thereof). In other embodiments, the first plurality of conduits may each comprise a distally positioned cross-member and a medially positioned cross-member, and the second plurality of conduits may each comprise no cross-members. In yet other embodiments, each of the plurality of conduits may comprise a distally positioned cross-member and a medially positioned cross-member.

In some embodiments, the plurality of conduits extending radially from the hub may comprise a pattern, the pattern alternating between a conduit of the first plurality of conduits and a conduit of the second plurality of conduits. In such embodiments, the pattern may thus alternate circumferentially between a conduit having a distally positioned cross-member, and a conduit having a medially positioned cross-member. In other embodiments, the pattern may alternate between a conduit having both a distally positioned cross-member and a medially positioned cross-member, and a conduit having no cross-members. In yet other embodiments, the plurality of conduits may comprise a non-alternating pattern.

In some embodiments, the number of conduits of the first plurality of conduits may be equal to the number of conduits of the second plurality of conduits. In other embodiments, the number of conduits of the first plurality of conduits may be greater or less than the number of conduits of the second plurality of conduits. In some embodiments, each conduit of the first plurality of conduits may extend radially from the hub opposite from another of the first plurality of conduits (e.g, at a central angle about the hub of approximately 180 degrees), each conduit of the second plurality of conduits may extend radially from the hub opposite from another of the second plurality of conduits, and the central angle between all radially adjacent conduits may be equal (e.g., the arc distance between the radial members of all adjacent conduits extending from the hub may be the same).

A filtration member of the present invention may comprise any shape which allows for permeability of water through the filtration member, but does not allow the passage of the granular media. In some embodiments, the filtration member may comprise a pod having a cylindrical barrier (e.g., a screen) with a first end and a second end, the first end being mounted to an outer surface of a conduit, around the perimeter of a passage through the conduit, and the second end being covered by a solid cap. The barrier may comprise a diameter in a range of about 40 millimeters to about 75 millimeters, and preferably in a range of about 50 millimeters to about 55 millimeters, and may comprise a length (e.g., a height) in a range of about 40 millimeters to about 100 millimeters, and preferably in a range of about 55 millimeters to about 65 millimeters. In some embodiments, the cap may comprise a greater diameter than the diameter of the cylindrical barrier (e.g., in a range of about 55 millimeters to about 90 millimeters, and preferably in a range from about 70 millimeters to about 80 millimeters).

The barrier may comprise openings which are sized to selectively allow water to pass through but prevent any granular media from passing. In some embodiments, the openings may comprise a plurality of substantially parallel slots, each slot being positioned horizontally and circumferentially spanning the cylindrical screen. In other embodiments, the plurality of slots may be positioned vertically and span the length (e.g., the height) of the cylindrical barrier between the cap and the conduit. In some embodiments the plurality of slots may each comprise a width in a range of about 0.2 millimeters to about 0.5 millimeters, and preferably may comprise a width of about 0.3 millimeters.

Multiple filtration members of the plurality of filtration members may be mounted to a single conduit of the plurality of conduits. In some embodiments, each conduit of a first plurality of conduits may comprise a radial member and a distally positioned cross-member, and each conduit of a second plurality of conduits may comprise a radial member and medially positioned cross-member. Each conduit of the first plurality of conduits may have a plurality of filtration members mounted thereto. For example, each conduit of the first plurality of conduits may have five filtration members mounted thereto, three filtration members being mounted along the length of the radial member and two filtration members being mounted on the cross-member, one on each side of the radial member. Each conduit of the second plurality of conduits may have a plurality of filtration members mounted thereto. For example, each conduit of the second plurality of conduits may have four filtration members mounted thereto, two filtration members being mounted to the radial member and two filtration members being mounted to the cross-member, one on each side of the radial member. One filter member may also be mounted to a central position on the hub.

In such embodiments, adjacent filtration members may be mounted at equal distances from each other. For example, of the three filtration members mounted to the radial member of a conduit of the first plurality of conduits, the distance between the proximal filtration member and the medial filtration member is the same as the distance between the medial filtration member and the distal filtration member, and the same as the distance between the distal filtration member and each of the filtration members mounted to the cross-member of the conduit. Correspondingly, each conduit of the second plurality of conduits may have distance between the two filtration members mounted to the radial member of the conduit which is the same as the distance between the two filtration members mounted to the cross-member of the conduit. In such embodiments, the overall pattern of the plurality of filtration members across the entire area of the vessel may form a squared grid wherein each filtration member is about equidistant from each of the closest adjacent filtration members, whether the closest adjacent filtration members are mounted to the same conduit or to a different conduit. The overall pattern of filtration members may thus provide an even flow of fresh water to all areas within a horizontal cross-section of the vessel. The granular media may thereby be disturbed and washed in an even and balanced manner during backflushing.

In other embodiments, the overall pattern of filtration members across a horizontal cross-section of the vessel may form a plurality of concentric rings centered on the hub, the hub also having a filtration member mounted to a central position thereon. In such embodiments, the distance between a proximal filtration member of a conduit and a medial filtration member of a conduit may be greater than the distance between the medial filtration member and a distal filtration member of the conduit.

The granular media may comprise a volume of small granules (e.g., granules having a diameter equal to or greater than 0.5 millimeters. In some embodiments, the granular media may comprise fine rock and mineral particles, (e.g., silica-based sand). In other embodiments, the granular media may comprise anthracite or other natural granular material. In yet other embodiments, the granular media may comprise manufactured, porous granules comprising a plastic or other similar processed granular material. In some embodiments, the granular media may be a composition comprising a plurality of materials chosen from the group comprising sand, anthracite, a plastic, and another similar natural or processed granular material.

In some implementations, the present invention provides a filtration system for filtering effluent water, the system comprising: granular media for filtering said effluent water; a vessel for holding said granular media, said vessel comprising a filtration inlet, a filtration outlet, a backflush inlet and a backflush outlet; a plurality of filtration members; and a conduit, said conduit being in fluid communication with said plurality of filtration members, said water outlet, and said backflush inlet. In some implementations, the conduit comprises a radial member and at least one cross member. In some implementations, the plurality of filter members are mounted at evenly spaced intervals on said radial member and said at least one cross member. In some implementations, the conduit comprises a plurality of conduits extending from a hub. In some implementations, the plurality of conduits are oriented radially and evenly about a circumference of said hub. In some implementations, each of said plurality of conduits comprises a radial member and at least one cross member. In some implementations, the plurality of filter members are mounted at evenly spaced intervals on each radial member and each cross member. In some implementations, a first conduit of said plurality of conduits comprises a distally positioned cross member and a second conduit of said plurality of conduits comprises a medially positioned cross member. In some implementations, the plurality of conduits comprises a first plurality of conduits and a second plurality of conduits, each conduit of said first plurality of conduits comprising a distally positioned cross member, and each conduit of said second plurality of conduits comprising a medially positioned cross member. In some implementations, the plurality of conduits comprises a pattern, the pattern alternating between a conduit of said first plurality of conduits and a conduit of said second plurality of conduits. In some implementations, each conduit of said first plurality of conduits extends from said hub at an angle approximately 180 degrees from another conduit of said first plurality of conduits, and each conduit of said second plurality of conduits extends from said hub at an angle approximately 180 degrees from another conduit of said second plurality of conduits. In some implementations, the plurality of filtration members comprises a squared grid pattern. In some implementations, each conduit of said plurality of conduits extends horizontally from said hub. In some implementations, each filter member of said plurality of filter members comprises a barrier having a plurality of openings. In some implementations, the barrier comprises a cylindrical shape and said plurality of openings comprises a plurality of slots. In some implementations, the plurality of slots are oriented horizontally. In some implementations, the barrier comprises a height in a range from about 55 millimeters to about 65 millimeters and a diameter in a range from about 50 millimeters to about 55 millimeters. In some implementations, the said granular media comprises sand. In some implementations, the granular media comprises a mixture of sand and another granular component. In some implementations, the vessel further comprises at least four ports for accessing an interior of said vessel. In some implementations, the vessel comprises a hydrodynamic shape.

In some implementations, the present invention provides a method of using a filter system to filter effluent water comprising the steps of: filling said vessel with said granular media until said granular media covers said plurality of filtration members; putting said filtration inlet in fluid communication with an effluent water source; putting said backflush inlet in fluid communication with a fresh water source; allowing said effluent water to flow into said vessel, through said filter media, into said plurality of filter members, through said plurality of conduits, and out through said water outlet; stopping said effluent water from flowing; allowing said fresh water to flow up through said plurality of conduits, out through said plurality of filter members, up through said filter media, and out through said water outlet, flushing debris and residue from said filter media.

Further objects and aspects of the present invention will be apparent from the description provided herein.

### BRIEF DESCRIPTION OF THE DRAWINGS

FIG. 1A shows a front, bisected view of a granular filtration system, according to an embodiment of the present invention.

FIG. 1B shows a side, bisected view of a granular filtration system, according to an embodiment of the present invention.

FIG. 2 shows a top, bisected view of a granular filtration system, according to an embodiment of the present invention.

FIG. 3A shows a side, bisected view of conduits and filtration members of a granular filtration system, according to an embodiment of the present invention.

FIG. 3B shows a side, bisected view of conduits and filtration members of a granular filtration system, according to an embodiment of the present invention.

FIG. 4A shows a rear view of a granular filtration system, according to an embodiment of the present invention.

FIGS. 4B shows a top view of a granular filtration system, according to an embodiment of the present invention.

FIG. 5A shows a side, sectional view of conduits and filtration members of a granular filtration system, according to an embodiment of the present invention.

FIG. 5B shows a side, sectional view of conduits and filtration members of a granular filtration system, according to an embodiment of the present invention.

### DETAILED DESCRIPTION OF THE DRAWINGS

Reference will now be made in detail to certain embodiments of the invention, examples of which are illustrated in the accompanying drawings. While the invention will be described in reference to these figures and certain implementations and examples of the embodiments, it will be understood that such implementations and examples are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. References to various features of the “present invention” throughout this document do not mean that all claimed embodiments or methods must include the referenced features. It will be apparent to one skilled in the art that the present invention may be practiced without these specific details or features.

Reference will be made to the exemplary illustrations in the accompanying drawings, and like reference characters may be used to designate like or corresponding parts throughout the several views of the drawings.

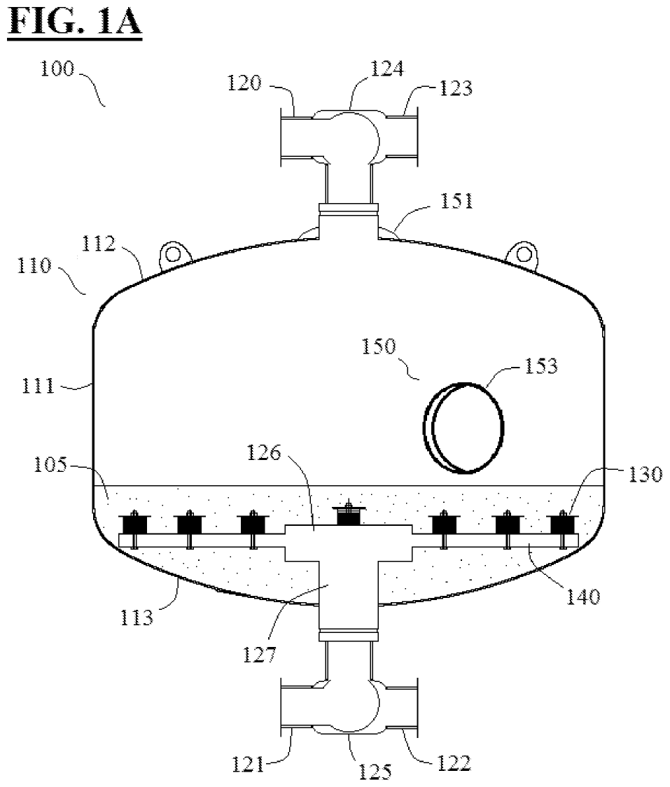

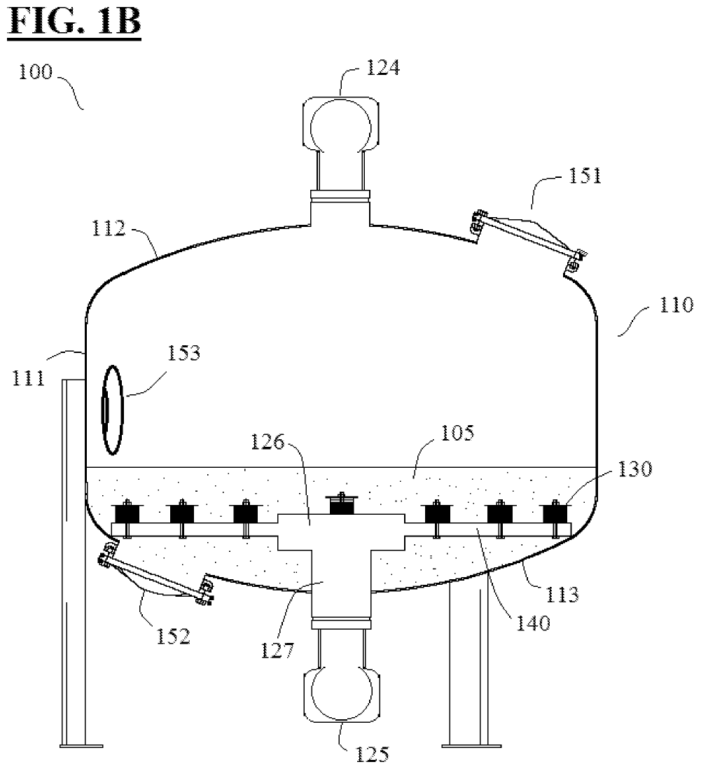

As seen in FIGS. 1A and 1B, the present invention may provide a granular filtration system 100 for filtering effluent water for agricultural operations. The system 100 may comprise a granular media 105 for filtering the effluent water, a vessel 110 for holding the granular media 105, a filtration inlet 120, a filtration outlet 121, a backflush inlet 122, a backflush outlet 123, a plurality of filtration members 130, and a plurality of conduits 140, the conduits 140 being in fluid communication with the plurality of filtration members 130, the filtration outlet 121, and the backflush inlet 122. The vessel may further comprise a plurality of access ports 150 for accessing the interior of the vessel 110.

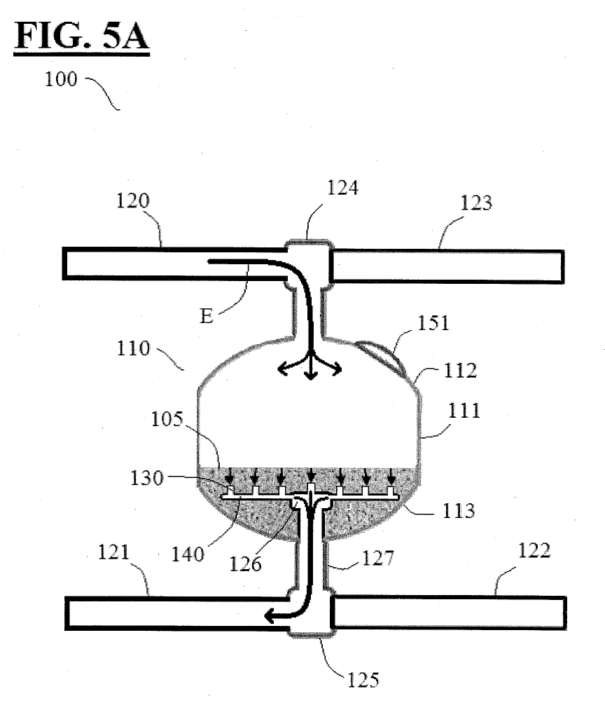

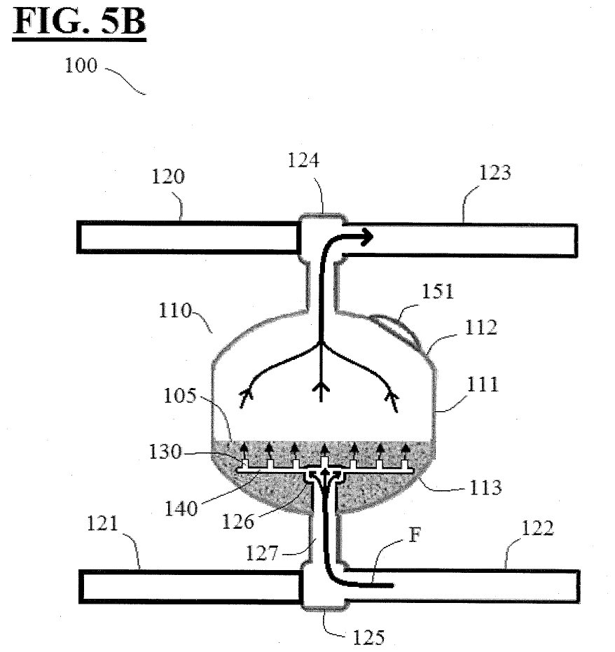

In some embodiments, the vessel 110 may comprise a shape having a cylindrical medial section 111 with substantially hemispherical upper 112 and lower 113 sections, providing a gently curving transition between the medial section 111 and each of the upper 112 and lower 113 sections. The vessel 110 may thus comprise a hydrodynamic shape, without sharp or acute angles to interrupt the flow of fresh water F (see FIG. 5B) from the bottom of the vessel 110 (e.g., from the filtration members 130) to the top of the vessel 110 (e.g., to the backflush outlet 123). The vessel 110 may also provide a hydrodynamic shape for the flow of effluent water E (see FIG. 5A) from the top of the vessel 110 (e.g., from the filtration inlet 120) to the bottom of the vessel 110 (e.g., to the granular media 105 and out through the filtration members 130).

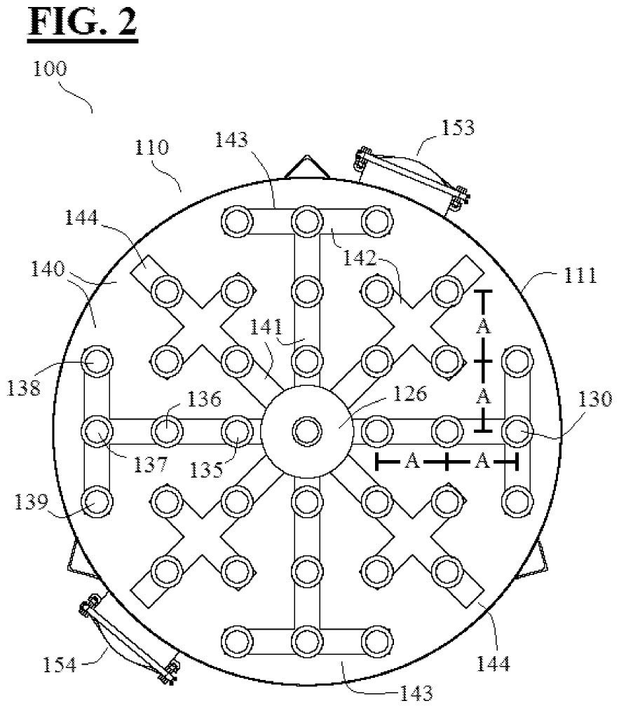

As seen in FIGS. 1A, 1B, and 2, the vessel 110 may comprise a material which is substantially impervious to rust (e.g., stainless steel) and a plurality of access ports 150, the plurality of access ports 150 being of sufficient size to allow for filling and draining of the granular media 105, and inspection and maintenance of the granular media 105, filtration members 130, and conduits 140 of the present system 100, which may be located inside the vessel 110. The vessel 110 may comprise a first port 151, a second port 152, a third port 153, and a fourth port 154. The first port 151 may be located in an upper wall 112 of the vessel 110 for pouring granular media into the vessel 110. The second port 152 may be located in a lower wall 113 of the vessel 110 for easily draining and sweeping the granular media 105 from the vessel 110. The third port 153 and the fourth port 154 may each be located in a medial wall 111 of the vessel 110 in substantially opposing positions (e.g., on opposite sides of the medial wall 111). The filtration members 130, conduits 140, and granular media 105 may thus be accessed from opposite sides of the vessel 110, allowing for more thorough inspection and maintenance.

The filtration inlet 120 may comprise a pipe or other channel providing a watertight connection between the vessel 110 and an effluent water source (not shown). The filtration inlet 120 may be connected to the vessel 110 at an apex thereof (e.g., at the highest point of the vessel 110). The filtration inlet 120 may connect to a first valve 124 at an apex of the vessel 110, the first valve 124 being operable to switch fluid communication with the vessel 110 from the filtration inlet 120 to the backflush outlet 123, and back to the filtration inlet 120. The first valve 124 may comprise a three-way ball valve well known in the art.

The filtration outlet 121 may comprise a pipe or other channel providing a watertight connection between the vessel and an agricultural irrigation device (e.g., drip tape; not shown). The filtration outlet 121 may connect to a second valve 125 at a low point of the vessel 110 (e.g., at the point where the plurality of conduits 140 converge and connect to the bottom of the vessel 110), the second valve 125 being operable to switch fluid communication with the vessel 110 from the filtration outlet 121 to the backflush inlet 122, and back to the filtration outlet 121. The second valve 125 may comprise a three-way ball valve well known in the art. The filtration outlet 121 may be in fluid communication with the vessel 110 only by way of the plurality of conduits 140 and the plurality of filtration members 130, thus preventing any effluent water from entering the filtration outlet 121 without first passing through the granular media and a filtration member 130.

The backflush inlet 122 may comprise a pipe or other channel providing a watertight connection between the vessel 110 and a fresh water source (not shown). The backflush inlet 122 may be connected to the vessel 110 at a low point thereof (e.g., at the point where the plurality of conduits 140 converge and connect to the bottom of the vessel 110). The backflush inlet 122 may connect to the vessel 110 via the second valve 125. The fresh water source (e.g., water under pressure from a municipal water source, or water from a well pressurized by a pump) may be under pressure sufficient to push water through the backflush inlet 122, through the plurality of conduits 140, out the plurality of filtration members 130, through the granular media 105, and out through the backflush outlet 123. In some embodiments, the flow of water from the fresh water source exiting the plurality of filtration members 130 may be sufficient to evenly disturb and wash the entirety of the granular media 105. The backflush inlet 122 may be in fluid communication with the vessel 110 only by way of the plurality of conduits 140 and the plurality of filtration members 130.

The backflush outlet 123 may comprise a pipe or other channel providing a watertight connection between the vessel and a wastewater exit (e.g., a pipe leading to a gathering pond or a wastewater drain). The backflush outlet 123 may connect to the vessel 110 via the first valve 124.

The system may comprise a central hub 126, and the plurality of conduits 140 may each comprise a radial member 141 and at least one cross-member 142, the radial member 141 extending substantially radially from the central hub 126 and the cross-member 142 extending substantially perpendicularly from the radial member 141. The hub 126 may comprise a short, cylindrical shape (e.g., a thick disc shape) and may be in fluid communication with an exit conduit 127 which extends from the hub 126 down through a low point of the vessel 110 and connects to the filtration outlet 121 and the backflush inlet 122 via the second valve 125. The plurality of conduits 140 may each extend horizontally from the hub 126.

The granular media 105 may comprise a volume of small granules (e.g., granules having a diameter greater than 0.3 millimeters. The granular media 105 may comprise fine rock and mineral particles, (e.g., silica-based sand).

As seen in FIG. 2, the plurality of conduits 140 may comprise a first plurality of conduits 143 and a second plurality of conduits 144, each conduit of the first plurality of conduits 143 comprising a cross-member 142 which is positioned distally on the radial member 141, and each conduit of the second plurality of conduits 144 each comprising a cross-member 142 which is positioned medially on the radial member 141.

The plurality of conduits 140 extending radially from the hub 126 may comprise a pattern, the pattern alternating between a conduit of the first plurality of conduits 143 and a conduit of the second plurality of conduits 144. The total number of the first plurality of conduits 143 may be equal to the total of the second plurality of conduits 144. Also, each conduit of the first plurality of conduits 143 may extend radially from the hub 126 opposite from another of the first plurality of conduits 143 (e.g, at a central angle about the hub 126 of approximately 180 degrees), and each conduit of the second plurality of conduits 144 may extend radially from the hub 126 opposite from another of the second plurality of conduits 144. Finally, the central angle between the radial members 141 of all adjacent conduits may be equal.

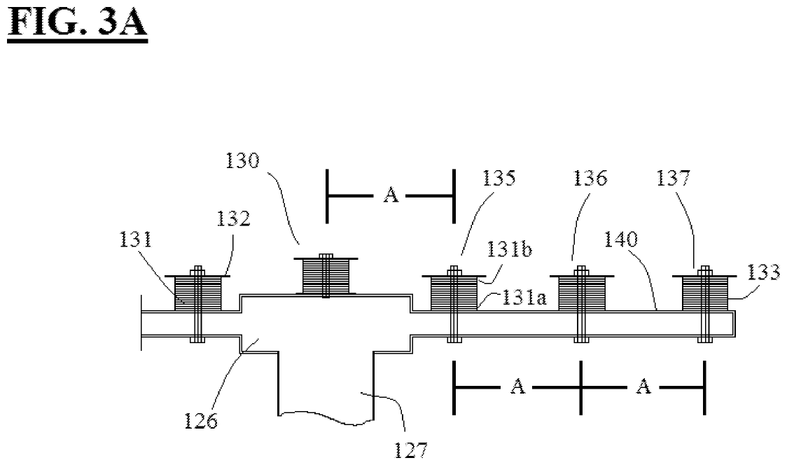

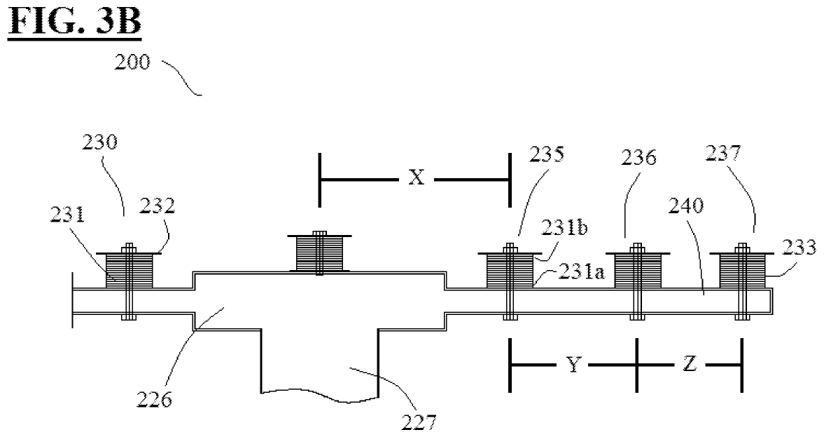

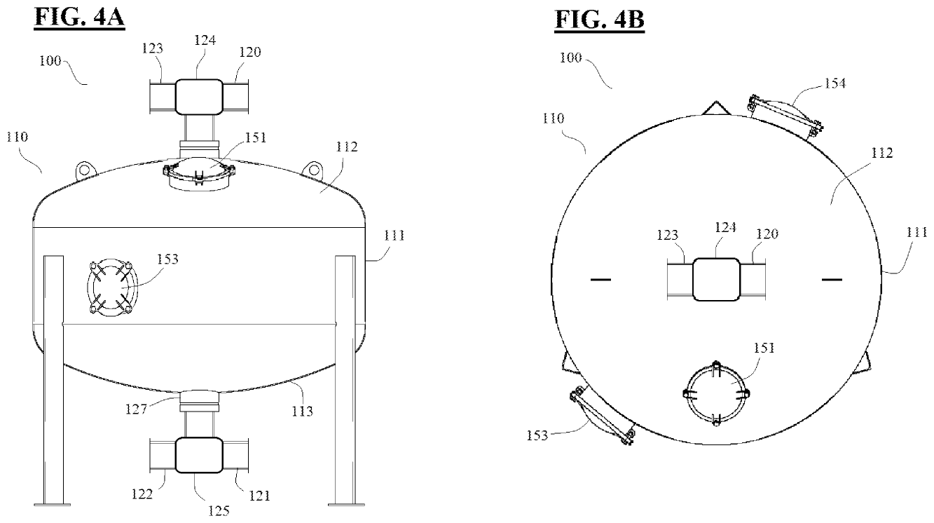

As best shown in FIG. 3A, each filtration member 130 of the present invention may comprise a pod having a cylindrical barrier 131 (e.g., a screen) with a first end 131a and a second end 131b, the first end 131a being mounted to an outer surface of a conduit 140, around the perimeter of a passage through the conduit 140, and the second end 131b being covered by a solid cap 132. The barrier 131 may comprise a diameter in a range of about 40 millimeters to about 75 millimeters, and preferably in a range of about 50 millimeters to about 55 millimeters, and may comprise a length (e.g., a height) in a range of about 40 millimeters to about 100 millimeters, and preferably in a range of about 55 millimeters to about 65 millimeters. In some embodiments, the cap 132 may comprise a greater diameter than the diameter of the cylindrical barrier 131 (e.g., in a range of about 55 millimeters to about 90 millimeters, and preferably in a range from about 70 millimeters to about 80 millimeters).

The barrier 131 may comprise a plurality of substantially parallel and horizontal slots 133 which are sized to selectively allow water to pass through but prevent any granular media 105 from passing. Each slot 133 may circumferentially span the cylindrical barrier 131, and may each comprise a width of about 0.3 millimeters.

Multiple filtration members of the plurality of filtration members 130 may be mounted to a single conduit of the plurality of conduits 140. Each conduit of the first plurality of conduits 143 may have five filtration members 130 mounted thereto, three filtration members being mounted along the length of the radial member 141 and two filtration members 130 being mounted on the cross-member 142, one on each side of the radial member 141. Each conduit of the second plurality of conduits 144 may have four filtration members 130 mounted thereto, two filtration members 130 being mounted to the radial member 141 and two filtration members 130 being mounted to the cross-member 142, one on each side of the radial member 141. One filter member 130 may also be mounted to a central position on the hub 126.

As shown in FIGS. 2 and 3A, adjacent filtration members 130 may be mounted at equal distances from each other. Of the three filtration members 130 mounted to the radial member 141 of a conduit of the first plurality of conduits 143, the distance A between the proximal filtration member 135 and the medial filtration member 136 is the same as the distance A between the medial filtration member 136 and the distal filtration member 137, and the same as the distance between the distal filtration member 137 and each of the filtration members 138, 139 mounted to the cross-member 142 of the conduit. Correspondingly, each conduit of the second plurality of conduits 144 may have a distance between the two filtration members 130 mounted to the radial member 141 of the conduit which is the same as the distance between the two filtration members 130 mounted to the cross-member 142 of the conduit. The overall pattern of the plurality of filtration members across the entire area of the vessel 110 may thus form a squared grid wherein each filtration member 130 is equidistant from each of the closest adjacent filtration members 130, whether the closest adjacent filtration members 130 are mounted to the same conduit or to a different conduit. The overall pattern of filtration members 130 may thus provide an even flow of fresh water to all areas within a horizontal cross-section of the vessel 110. The granular media 105 may thereby be disturbed and washed in an even and balanced manner during backflushing.

FIG. 3B shows an embodiment 200 of the present invention wherein a distance X between the filtration member 230 mounted to the hub 226 and a proximal filtration member 235 is greater than a distance Y between the proximal filtration member 235 and a medial filtration member 236, which may be greater than a distance Z between the medial filtration member 236 and a distal filtration member 237. In such embodiments, the overall pattern of filtration members 230 across a horizontal cross-section of the vessel may form a plurality of concentric rings centered on the hub 226.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. A filtration system for filtering effluent water, the system comprising:
a. granular media for filtering said effluent water;
b. a vessel for holding said granular media, said vessel comprising a filtration inlet, a filtration outlet, a backflush inlet and a backflush outlet; and
c. a plurality of filtration members mounted at evenly spaced intervals on at least one conduit having a radial member and at least one cross member,
said conduit being in fluid communication with said water outlet, and said backflush inlet.

2. (canceled)

3. (canceled)

4. The system of claim 1, wherein said at least one conduit comprises a plurality of conduits extending from a hub.

5. The system of claim 4, wherein said plurality of conduits are oriented radially at regular radial intervals about a circumference of said hub.

6. The system of claim 5, wherein each of said plurality of conduits comprises a radial member and at least one cross member.

7. The system of claim 6, wherein said plurality of filter members are mounted at evenly spaced intervals on each radial member and each cross member.

8. The system of claim 7, wherein a first conduit of said plurality of conduits comprises a distally positioned cross member and a second conduit of said plurality of conduits comprises a medially positioned cross member.

9. The system of claim 7, wherein said plurality of conduits comprises a first plurality of conduits and a second plurality of conduits, each conduit of said first plurality of conduits comprising a distally positioned cross member, and each conduit of said second plurality of conduits comprising a medially positioned cross member.

10. The system of claim 9, wherein said plurality of conduits comprises a pattern, the pattern alternating between a conduit of said first plurality of conduits and a conduit of said second plurality of conduits.

11. (canceled)

12. The system of claim 9, wherein the plurality of filtration members comprises a squared grid pattern.

13. (canceled)

14. (canceled)

15. (canceled)

16. The system of claim 1, wherein each filter member of said plurality of filter members comprises a barrier having a plurality of openings.

17. (canceled)

18. (canceled)

19. (canceled)

20. (canceled)

21. (canceled)

22. (canceled)

23. A method of using a filter system to filter effluent water, said filter system comprising:
a backflushing a vessel comprising a granular media through a plurality of conduits, said plurality of conduits positioned within said granular media, wherein each conduit includes a radial member and at least one cross member, said plurality of filtration members are positioned on said radial member and said at least one cross member.

24. The method of claim 23, wherein said filter system further comprises a hub, said plurality of conduits extending radially from said hub and comprising a pattern of cross members alternating between a medial position and a distal position.

25. (canceled)

26. The method of claim 25, wherein said plurality of filtration members are mounted at evenly spaced intervals on said radial member and said at least one cross member.

27. The method of claim 23, wherein said plurality of conduits extend from a hub in a radial orientation at regular radial intervals about a circumference of said hub.

28. (canceled)

29. (canceled)

30. (canceled)

31. (canceled)

32. The method of claim 27, wherein said plurality of conduits comprises a first plurality of conduits and a second plurality of conduits, each conduit of said first plurality of conduits comprising a distally positioned cross member, and each conduit of said second plurality of conduits comprising a medially positioned cross member.

33. (canceled)

34. (canceled)

35. The method of claim 33, wherein the plurality of filtration members comprises a squared grid pattern.

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. A filtration system for filtering effluent water, the system comprising:
a. a vessel for holding a granular media;
b. a plurality of conduits mounted on a central hub and oriented radially about a circumference of said hub, each having a radial member and at least one cross member; and
c. a plurality of filtration members mounted at evenly spaced intervals on said radial member and said at least one cross member of each of said plurality of conduits.

72. The system of claim 71, wherein said plurality of conduits are oriented radially at regular radial intervals about a circumference of said hub.

73. The system of claim 71, wherein said plurality of filter members are mounted at evenly spaced intervals on each radial member and each cross member.

74. The system of claim 71, wherein said plurality of conduits comprises a first plurality of conduits and a second plurality of conduits, each conduit of said first plurality of conduits comprising a distally positioned cross member, and each conduit of said second plurality of conduits comprising a medially positioned cross member.

75. The system of claim 74, wherein said plurality of conduits comprises a pattern, the pattern alternating between a conduit of said first plurality of conduits and a conduit of said second plurality of conduits.

76. The system of claim 74, wherein the plurality of filtration members comprises a squared grid pattern.

77. The system of claim 71, wherein each filter member of said plurality of filter members comprises a barrier having a plurality of openings.
